(19) United States
(12) Patent Application Publication
(10) Pub. No.: US 2026/0186129 A1
(43) Pub. Date: Jul. 2, 2026

(54) SYSTEM AND METHOD FOR DETECTING OBJECT INFORMATION BASED ON SYNTHETIC APERTURE RADAR IMAGES

(71) Applicant: STELLARVISION INC., Daejeon (KR)

(72) Inventor: Seung Chul Lee, Seoul (KR)

(21) Appl. No.: 18/861,134

(22) PCT Filed: Aug. 23, 2024
(86) PCT No.: PCT/KR2024/012580

§ 371 Date: Oct. 28, 2024

(30) Foreign Application Priority Data
Aug. 24, 2023 (KR) 10-2023-0111608
Apr. 16, 2024 (KR) 10-2024-0050895

(51) Int. Cl. G01S 13/90; G01S 13/58; G06T 7/246; G06T 7/507

(52) U.S. Cl. CPC G01S 13/9029; G01S 13/588; G01S 13/9027; G01S 13/9094; G06T 7/251; G06T 7/507; G06T 2207/10028; G06T 2207/20081

(57) ABSTRACT

An object information detection system based on a synthetic aperture radar image according to an embodiment of the present invention may comprise: a receiver module for receiving an image of a synthetic aperture radar (SAR); and a processing module for extracting shadows defined as shaded areas where electromagnetic waves cannot reach in the received image, distinguishing artificial objects that reflect electromagnetic waves and natural objects that absorb electromagnetic waves in the received image, and calculating information of the distinguished objects. The processing module may further include a moving target object processing module that determines an actual position of a moving object moving with velocity among the artificial objects based on the position of the extracted shadow and/or a natural object processing module that distinguishes natural objects that absorb at least a part of electromagnetic waves.

### TECHNICAL FIELD

The present invention relates to a system and method for detecting object information using shadows in a synthetic aperture radar (SAR) image.

More specifically, the present invention relates to a system and method for accurately detecting or detecting information about natural objects that have relatively high absorption characteristics of electromagnetic waves from synthetic aperture radar and artificial objects that have relatively high reflectivity characteristics of said electromagnetic waves, using shadows of each object.

### BACKGROUND ART

Generally, synthetic aperture radar (hereinafter referred to as SAR) identifies the location or characteristics of a target by transmitting electromagnetic waves and receiving signals reflected from the target. For example, the synthetic aperture radar (SAR) mounted on satellites, aircraft, drones, etc. detects objects by analyzing the Doppler shift of electromagnetic waves caused by the movement of objects on the ground.

The Doppler shift is defined as the amount of predictable change in the received signal frequency caused by the change in distance between the transmission point and the reception point. Meanwhile, the greater the approaching or receding velocity due to the Doppler effect, the greater the Doppler shift.

The raw data collected by the synthetic aperture radar (SAR) is converted into a two-dimensional level 1 (LEV.1) image that can be recognized by humans through a series of digital signal processing. Here, the raw data can be converted into a level 1 image through a range compression process and an azimuth compression process. For example, Range Doppler Algorithm (RDA) and Back Projection Algorithm (BPA) are used as signal compression techniques for converting to level 1 images.

Meanwhile, objects that reflect electromagnetic waves of synthetic aperture radar (SAR), for example, artificial objects or metal objects with relatively high reflectivity, may be able to move with velocity on the ground or at sea. For example, GMTI (Ground Moving Target Indication) technology can be understood as a synthetic aperture radar (SAR) system that identifies moving objects on the ground.

Hereinafter, artificial objects or metal objects with relatively high reflectivity moving with velocity are referred to as ‘moving objects’.

As such, due to the aforementioned Doppler effect, the moving object on the ground or at sea is positioned at a shifted position rather than the actual position in the level 1 image of the synthetic aperture radar (SAR).

However, with conventional technology, it is difficult to calculate how much the moving object is shifted from its actual position in the level 1 image with only the information that can be obtained through a single synthetic aperture radar (SAR). Also, with the conventional technology, it is difficult to calculate the exact moving direction and velocity of the moving object using a single synthetic aperture radar.

For this reason, in order to detect or calculate the actual position, moving velocity, moving direction, etc. of the moving object using the characteristics of the Doppler effect, methods using multiple (at least a pair of) synthetic aperture radars (SAR) are widely used in the related technical field. For example, as a method for analyzing and resolving the incorrect position of the moving object in the level 1 image, the ATI (Along-Track Interferometry)-SAR method using a pair of synthetic aperture radars (SAR) has recently been preferred.

However, the ATI-SAR method requires relatively high costs and is less economical because it requires revisiting the same area by satellite to detect information, or operating a satellite equipped with two SAR sensors (or modules) or two satellites. Also, methods requiring multiple synthetic aperture radars (SAR) like ATI-SAR are heavy or bulky in that they need to process relatively large amounts of image information. In addition, methods requiring multiple synthetic aperture radars (SAR) have problems in that image processing to the next level becomes complicated and difficult because multi-satellite matching correction, time series change correction, etc. are required in terms of information processing methods.

Meanwhile, as described above, the synthetic aperture radar (SAR) image can be obtained through processing for the flight (Azimuth) direction of the SAR carrier and the electromagnetic wave transmission/reception direction, which is the range direction. Here, only when the range direction of SAR and the moving direction of the moving object form a horizontal, it is possible to calculate the velocity and moving direction of the moving object by calculating the correction value for the delay time of electromagnetic wave reception due to the Doppler effect with only the acquisition information by a single synthetic aperture radar (SAR). In other words, in most cases where the moving direction of the moving object and the range direction of SAR are not horizontal, it is difficult to calculate the correction value with only the acquisition information by a single synthetic aperture radar (SAR). For example, with a single synthetic aperture radar (SAR), it is possible to analyze the effect of the Doppler effect on changes in horizontal component vector values, but it is difficult to analyze the effect of changes in vertical component vector values.

In other words, with only the information from a single synthetic aperture radar (SAR), it is difficult to detect or calculate the actual position, moving velocity, moving direction, etc. by analyzing the Doppler shift of the moving object, and the reliability of the results is low.

Meanwhile, as described above, objects that have relatively low reflectivity and allow electromagnetic waves to penetrate (penetrate or absorb) rather than objects that reflect most of the electromagnetic waves of synthetic aperture radar (SAR) with relatively high reflectivity can be defined. Here, objects with relatively low reflectivity can also be understood as objects with high absorptivity.

Hereinafter, objects that have relatively low reflectivity and allow electromagnetic waves to penetrate or be absorbed are referred to as ‘natural objects’. The natural objects can be understood to have a significantly lower backscattering coefficient of electromagnetic waves compared to the artificial objects (including metal objects).

Since the natural objects absorb most of the electromagnetic waves or reflect only a relatively small part, there is a limitation in clearly sensing, detecting, calculating or analyzing information related to shape, position, etc. in the synthetic aperture radar.

In other words, compared to artificial objects that reflect electromagnetic waves at relatively high values, natural objects are difficult to clearly specify or classify their shape in the synthetic aperture radar image. Therefore, with conventional technology, it is difficult to judge or identify what kind of object the natural object is in the synthetic aperture radar image.

The prior art related to the above-described conventional technology includes KR 10-2420978 B1, KR 10-2019-0133442 A, KR 10-2531068 B1, KR 10-2482150 B1, KR 10-2020-0087340 A.

### DISCLOSURE

### Technical Problem

An object of the present invention is to provide a system and method for detecting object information based on synthetic aperture radar images that can solve the problems of the conventional technology described above.

Another object of the present invention is to provide a system and method for detecting information about moving artificial objects based on shadow analysis of synthetic aperture radar images.

Another object of the present invention is to provide a system and method for detecting moving object information based on a single synthetic aperture radar (SAR) that can obtain highly reliable results using machine learning (including deep learning).

Another object of the present invention is to provide an economically inexpensive and relatively simple processing system and method for detecting moving object information based on a single synthetic aperture radar (SAR).

Another object of the present invention is to provide a system and method that can easily obtain information about natural objects with relatively low electromagnetic wave reflectivity of synthetic aperture radar in synthetic aperture radar images.

Another object of the present invention is to provide a system and method for identifying the shape and type of natural objects based on shadow analysis of synthetic aperture radar images using machine learning.

Another object of the present invention is to provide a system and method for detecting information about natural objects using the relationship between the characteristics of natural objects and their shadows in synthetic aperture radar (SAR) images.

### Technical Solution

To achieve the above objects of the present invention, a system for detecting object information based on synthetic aperture radar images according to an embodiment of the present invention may include: a receiver module for receiving an image of a synthetic aperture radar (SAR); and a processing module for extracting shadows defined as shaded areas where electromagnetic waves cannot reach in the received image, discriminating artificial objects that reflect electromagnetic waves in the received image, and calculating information of the discriminated objects.

In addition, the processing module may include a moving target object processing module that determines the actual position of a moving object moving with velocity among the artificial objects based on the position of the extracted shadow.

In addition, the moving target object processing module may include: a boundary setting unit that sets a boundary based on the maximum velocity of the moving object to match the extracted shadow with the moving object; and a target-shadow matching unit that detects a shadow of the moving object using a machine learning model.

In addition, the shadow of the moving object may be detected within the boundary set by the boundary setting unit.

In addition, the machine learning model may repeatedly generate normalizing data by mixing virtual shadow learning data that simulates changes in synthetic aperture radar environment variables and actual shadow data acquired through actual synthetic aperture radar images.

In addition, the machine learning model may perform repeated learning based on the normalizing data so that an F1-score defined as the harmonic mean of precision and recall is acquired to be 0.8 or higher.

In addition, the boundary setting unit may vary the size of the boundary based on the maximum velocity of the moving object.

In addition, the machine learning model may simulate and store virtual shadow data according to changes in synthetic aperture radar environment variables based on 3D models of artificial objects with high electromagnetic wave reflectivity to generate virtual shadow learning data.

In addition, the machine learning model may learn by mixing virtual shadow data generated by changes in synthetic aperture radar environment variables and actual shadow data acquired by actual synthetic aperture radar images at a predetermined maximum ratio.

In addition, the target-shadow matching unit may include: a machine learning model generation unit that generates shadow learning data of synthetic aperture radar images for each moving object by distinguishing moving objects by category and generates a machine learning model for shadow detection and matching; and a matching result acquisition unit that matches the moving object and shadow through the machine learning model generated by the machine learning model generation unit and acquires information of the moving object based on the position of the shadow.

In addition, the matching result acquisition unit may calculate a beta angle defined as the angle between the direction in which the synthetic aperture radar views the moving object and the direction in which the moving object faces forward from the position of the matched shadow.

In addition, the moving target object processing module may further include: a target information calculation unit that acquires the moving velocity or moving direction of the moving object based on the determined actual position of the moving object; and a correction module that reprocesses the synthetic aperture radar image by reflecting the moving velocity or moving direction or shifted position information of the moving object.

In addition, the moving object may appear at a position separated from the shadow in the image received by the reception module, and the moving target object processing module may filter out objects connected to shadows in the received image as not being the moving object.

In addition, the receiver module may receive a level 1 image of a single synthetic aperture radar, and the moving target object processing module may further include a target setting unit that filters out stationary objects with no velocity in the received level 1 image and targets moving objects that are the subject of information detection.

In addition, the boundary setting unit may search for shadows that can be matched with the moving target object by setting a boundary based on the maximum velocity of the moving target object set in the target setting unit.

In addition, the target-shadow matching unit may determine a shadow matching the moving target object within the set boundary.

In addition, the moving target object processing module may further include a target information calculation unit that calculates velocity and direction information of the moving target object based on the determined shadow.

In addition, the boundary setting unit may determine the boundary by the mathematical formula Δ=Rv/V (Δ=maximum position displacement for boundary setting, R=distance between moving object and synthetic aperture radar carrier, V=velocity of synthetic aperture radar carrier, v=maximum velocity of moving target object).

In addition, the actual position of the moving target object in the received level 1 image may be determined as the position connected to the matched shadow.

In addition, the processing module may further include a natural object processing module that discriminates natural objects that absorb at least a part of electromagnetic waves.

In addition, the natural object processing module may include: a shadow identification unit that identifies natural objects forming shadows using a machine learning model from the extracted shadows; and a shadow extraction unit that filters to detect and extract shadows formed by the natural objects in the image received from the reception module.

In addition, the processing module according to an embodiment of the present invention may include at least one of the natural object processing module and the moving target processing module. Specifically, the processing module may selectively include either the natural object processing module or the moving target processing module, or may include both the natural object processing module and the moving target object processing module.

In addition, the shadow extraction unit may detect shadows formed by natural objects by selecting shadows whose visible shape of the source object is unclear in the received image.

In addition, the shadow extraction unit may search for shadows with unclear visible shapes by applying a window with variable size within the received image.

In addition, the shadow identification unit may include: a machine learning model generation unit that generates shadow learning data of synthetic aperture radar level 1 images for natural objects classified by category and repeatedly learns to generate a machine learning model; and a matching result acquisition unit that acquires natural objects identified from the extracted shadows through the machine learning model generated by the generation unit. Here, the machine learning model may repeatedly learn about a shadow of the certain natural object characteristic or a characteristic of a shadow that the certain natural object may has.

In addition, the natural object processing module may further include: a shadow enhancement unit that enhances signals or images of shadows that natural objects can form through filtering techniques; and an object information calculation unit that calculates information about the natural object identified by the shadow identification unit from the extracted shadow.

From another perspective, a method for detecting object information based on synthetic aperture radar images according to an embodiment of the present invention may include: receiving an image of a synthetic aperture radar; extracting shadows defined as shaded areas where electromagnetic waves cannot reach in the received image; selecting moving objects with velocity among artificial objects that reflect electromagnetic waves in the received image, excluding stationary objects with no velocity and shadows connected to the stationary objects, to set moving target objects; setting a boundary for each moving target object based on the maximum velocity of the moving target object; matching shadows located within the set boundary with the moving target object using a machine learning model for each moving target object; loading beta angle information based on the matched moving target object and shadow in a matching result acquisition step; and calculating the moving velocity of the moving target object using the mathematical formula

$${V}_{moving velocity} = \frac{{V}_{s} Δ D}{R cos ( β )}$$

(Vs=velocity of synthetic aperture radar carrier, Δ=distance between matched shadow and moving target object, R=distance between synthetic aperture radar carrier and moving target object, β=angle at which moving target object is facing based on direction in which synthetic aperture radar views moving target object) based on the acquired matching result.

In addition, the method for detecting object information based on synthetic aperture radar images may further include feeding back the matched shadow and moving target object result to the boundary setting step by storing it.

In addition, the machine learning model for matching shadows located within the set boundary with the moving target object may include: inputting 3D models of artificial objects with high electromagnetic wave reflectivity by category to generate virtual shadow data; generating and storing virtual shadow data according to changes in synthetic aperture radar environment variables based on the input 3D models; normalizing by mixing virtual shadow data generated for combinations of changes in synthetic aperture radar environment variables and actual shadow data acquired by actual synthetic aperture radar images at a predetermined maximum ratio; and repeatedly learning based on the normalizing data so that an F1-score (F1-score) is satisfied to be 0.8 or higher.

From another perspective, a method for detecting object information based on synthetic aperture radar images according to an embodiment of the present invention may include, in an object information detection system including: a receiver module for receiving a synthetic aperture radar image; and a processing module for extracting shadows defined as shaded areas where electromagnetic waves cannot reach in the received image and calculating information of natural objects that absorb at least a part of electromagnetic waves based on the extracted shadows: a filtering step of selecting shadows whose visible source object is not identified among the extracted shadows; a step of inferring or identifying natural objects from the shadows that passed through the filtering step using a machine learning model; and a step of calculating information of the inferred or identified natural objects based on the size and shape of the extracted shadows.

In addition, the information of the inferred or identified natural objects may include the position, length, size, and occupied area of the natural objects.

In addition, the machine learning model used to infer or identify natural objects may repeatedly learn about a shadow of the certain natural object characteristic or a characteristic of a shadow that the certain natural object may has.

From another perspective, a system for detecting object information based on synthetic aperture radar images according to an embodiment of the present invention may include: a receiver module for receiving an image of a synthetic aperture radar (SAR); and a processing module for detecting the actual position of a moving object that reflects electromagnetic waves in the received image.

In addition, the processing module may detect a shadow defined as an area where electromagnetic waves cannot reach due to the moving object, and determine the actual position of the moving object as the position of the detected shadow.

From another perspective, an object information detection system based on synthetic aperture radar images according to an embodiment of the present invention may include: a SAR image receiver module for receiving a level 1 image of a single synthetic aperture radar (SAR); and a moving target object processing module for acquiring information about objects moving with velocity in the received level 1 image. Here, the moving target object processing module may include a target setting unit that performs pre-filtering to exclude objects with no moving velocity in order to set moving target objects in the received level 1 image.

In addition, the moving target object processing module may include a boundary setting unit that sets a boundary based on the maximum velocity of the moving target object to search for shadows that can be matched with the moving target object. Here, the shadow is defined as an area where electromagnetic waves cannot reach due to the moving target object.

In addition, the moving target object processing module may include a target information calculation unit that calculates moving speed information based on the shadow matched by a target-shadow matching unit and the moving target object.

In addition, the actual position of the moving target object in the received level 1 image may be determined as the position connected to the matched shadow.

In addition, the target information calculation unit may calculate the moving velocity using the mathematical formula

$${V}_{moving velocity} = \frac{{V}_{s} Δ D}{R cos ( β )} .$$

In addition, the target information calculation unit may provide moving direction information at the actual position of the moving target object.

In addition, the target setting unit may perform pre-filtering by deep learning methods for object extraction or by removing objects with predetermined scattering coefficient characteristics.

In addition, the target-shadow matching unit may include: a machine learning model generation unit that generates shadow learning data of synthetic aperture radar (SAR) level 1 images for objects classified by category hierarchically and generates a machine learning model for matching moving target objects and shadows; and a matching result acquisition unit that acquires shadows matched to moving target objects within the set boundary through the machine learning model generated by the machine learning model generation unit, and acquires a beta angle based on the acquired shadow, where the beta angle is defined as the angle between the direction in which the synthetic aperture radar (SAR) views the moving target object and the direction in which the moving target object faces forward.

From another perspective, the object information detection system based on synthetic aperture radar images according to an embodiment of the present invention may include: a receiver module for receiving an image of a synthetic aperture radar; and a processing module for extracting shadows defined as shaded areas where electromagnetic waves cannot reach in the received image, and identifying natural objects that allow at least part of the electromagnetic waves to penetrate based on the extracted shadows.

In addition, the processing module may include a shadow identification unit that identifies natural objects forming the extracted shadows using a machine learning model.

Furthermore, the processing module may include a shadow extraction unit that filters to detect and extract shadows formed by the natural objects in the image received from the reception module.

### Advantageous Effects

According to the present invention, by utilizing a shadow of a specific object in a synthetic aperture radar image, highly reliable object information can be detected based on the property of an object that is differently defined according to reflection or absorption of an electromagnetic wave of the synthetic aperture radar.

According to the present invention, by using a shadow in a synthetic aperture radar image, it is possible to determine whether a specific object is a moving artificial object, and to obtain information on the exact position, velocity, and direction of the identified object. Furthermore, the acquired information can be used to reprocess the image.

According to the present invention, by using a shadow in a synthetic aperture radar image, it is possible to determine whether a specific object is a natural object, and to clearly identify the shape and type of the identified object. Furthermore, the acquired information can be used to reprocess the image.

According to the present invention, by using the shadow of a specific object in a synthetic aperture radar image, the reliability and accuracy between the image and reality can be improved, and furthermore, the reliability and accuracy of the information of a detectable object can be improved.

According to the present invention, there is an advantage that information such as the actual position, moving velocity, and moving direction of a moving object in a level 1 image can be obtained with only the information acquired from a single synthetic aperture radar.

According to the present invention, since it uses a method of obtaining actual information of a moving object based on a shadow fixed in position, there is an advantage that highly reliable information can be obtained through a single synthetic aperture radar.

According to the present invention, there is an advantage that information such as the actual position and moving velocity of a moving object can be calculated even in a direction that is not horizontal to the range direction with only the information obtained from a single synthetic aperture radar.

According to the present invention, there is an advantage that information processing for a moving object becomes simpler and more economical compared to methods using at least a pair of synthetic aperture radars.

According to the present invention, information can be obtained from the synthetic aperture radar image even for a natural object with relatively high electromagnetic wave absorption rate using shadow.

According to the present invention, since a natural object can be determined and analyzed based on a shadow detected in the synthetic aperture radar, the inherent limitation due to the operating principle of the synthetic aperture radar can be overcome.

According to the present invention, by using machine learning that repeatedly learns the shadow characteristics that a natural object can have according to various environmental factors in synthetic aperture radar, the natural object having detected shadow can be inferred. Therefore, even if an actual natural object does not appear visibly in the synthetic aperture radar image, the natural object can be identified and reflected in the output results.

According to the present invention, the reliability of the results can be relatively improved because the correlation between a natural object and shadow is machine-learned based on the shape and characteristic of the shadow.

According to the present invention, by using a shadow defined by the property that at least some electromagnetic wave is reflected even for a natural object that is difficult to detect conventionally, the functionality of synthetic aperture radar image information can be expanded.

According to the present invention, by going through a filtering process to detect shadows without visible objects around them, a more enhanced and precise synthetic aperture radar image can be provided.

According to the present invention, there is an advantage that the presence and a type of a natural object can be estimated by analyzing a shadow defined by the synthetic aperture radar.

According to the present invention, a machine learning model can be provided that recognizes patterns and features of a shadow that correlate with specific type of a natural object.

According to the present invention, by analyzing the synthetic aperture radar image from a shadow that cannot find a clear source, the existence of a natural object can be inferred, and the type of the natural object can be classified based on the shadow.

According to the present invention, the functionality of synthetic aperture radar can be greatly expanded in environmental monitoring, disaster management, and other applications where it is difficult to directly detect natural objects. Moreover, along with the functional expansion of remote sensing technology, a new sensing system can be provided that can accurately and efficiently detect natural objects in various environments.

### DESCRIPTION OF DRAWINGS

FIG. 1 is a diagram schematically showing the configuration of an object information detection system based on a synthetic aperture radar image according to an embodiment of the present invention.

FIG. 2 is a diagram showing the configuration of the moving target object processing module of FIG. 1.

FIG. 3 is a flow chart showing a method for detecting moving object information based on a synthetic aperture radar image according to an embodiment of the present invention.

FIG. 4 is a flow chart showing a machine learning model according to an embodiment of the present invention.

FIG. 5 is a diagram showing virtual shadow images generated for each angle of an object in the machine learning model of FIG. 4.

FIG. 6 is a flow chart showing in detail the matching verification step among the methods for detecting moving object information based on a synthetic aperture radar image according to an embodiment of the present invention.

FIG. 7 is a diagram exemplarily explaining the concept for calculating the distance between a moving target object and a shadow within a boundary according to an embodiment of the present invention.

FIG. 8 is a diagram exemplarily showing the calculation of information between a moving target object and a matching shadow in a level 1 image of a single synthetic aperture radar according to an embodiment of the present invention.

FIG. 9 is a diagram showing the configuration of the natural object processing module of FIG. 1.

FIG. 10 is a flow chart showing a method for detecting natural object information based on a synthetic aperture radar image according to an embodiment of the present invention.

FIG. 11 is a flow chart showing in detail the step of verifying natural objects among the methods for detecting natural object information based on a synthetic aperture radar image according to an embodiment of the present invention.

FIG. 12 is a diagram showing an artificial object (MO) with relatively clear shape due to high electromagnetic wave reflectivity in a synthetic aperture radar image and its shadow (MOS).

FIG. 13 is a diagram showing an image of a natural object (NO) with relatively unclear shape due to low electromagnetic wave reflectivity in a synthetic aperture radar image and its shadow (NOS).

### BEST MODE

### Mode for Invention

Hereinafter, some embodiments of the present invention will be described in detail through exemplary drawings. It should be noted that in adding reference numerals to the components of each drawing, the same components are given the same reference numerals as much as possible, even if they are shown in different drawings. Also, in explaining embodiments of the present invention, if it is determined that a detailed description of related known configurations or functions may unnecessarily obscure the gist of the present invention, the detailed description will be omitted.

In addition, terms such as first, second, A, B, (a), (b), etc. may be used in describing components of embodiments of the present invention. These terms are only used to distinguish one component from other components, and the nature, order or sequence, etc. of the corresponding component is not limited by these terms. When a component is described as being “connected”, “coupled” or “joined” to another component, it should be understood that the component may be directly connected or coupled to the other component, but another component may also be “connected”, “coupled” or “joined” between the components.

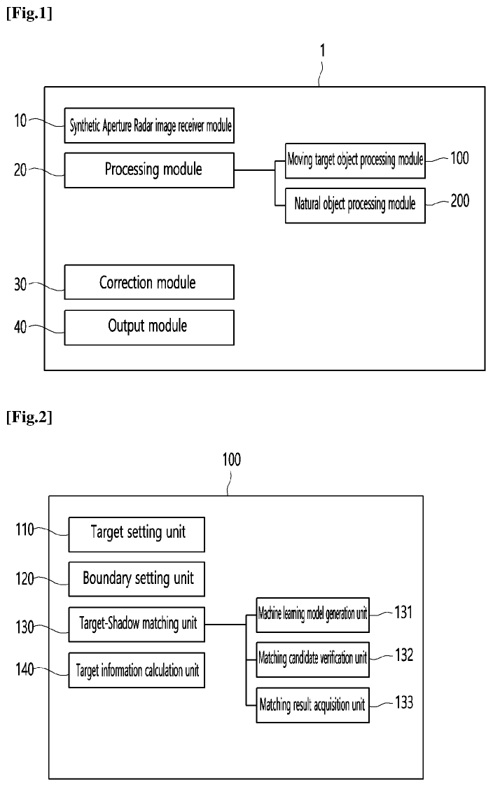

FIG. 1 is a diagram schematically showing the configuration of an object information detection system based on a synthetic aperture radar image according to an embodiment of the present invention.

The synthetic aperture radar may be provided on a carrier such as a satellite, aircraft, drone, etc. For example, a small satellite equipped with a single synthetic aperture radar can capture (i.e., transmit and receive electromagnetic waves) an object on the ground and/or sea along its flight orbit. Here, the object can be understood as an artificial object or a natural object.

Referring to FIG. 1, the object information detection system (1) based on a synthetic aperture radar image according to an embodiment of the present invention may include a receiver module (10) that receives a synthetic aperture radar (hereinafter referred to as ‘SAR’) image and a processing module (20) that extracts shadows from the image received by the receiver module (10) to acquire object information.

Hereinafter, a shadow can be defined as shaded area generated in the received synthetic aperture radar image where an electromagnetic wave cannot reach.

The processing module (20) can extract the shadow to determine whether it is from an artificial object that reflects an electromagnetic wave or a natural object that absorbs an electromagnetic wave in the received image.

In addition, the processing module (20) can calculate or acquire information about the determined object using the extracted shadow corresponding to the determined object.

Meanwhile, as described above, an object with relatively high electromagnetic wave reflectivity can be defined as an artificial object.

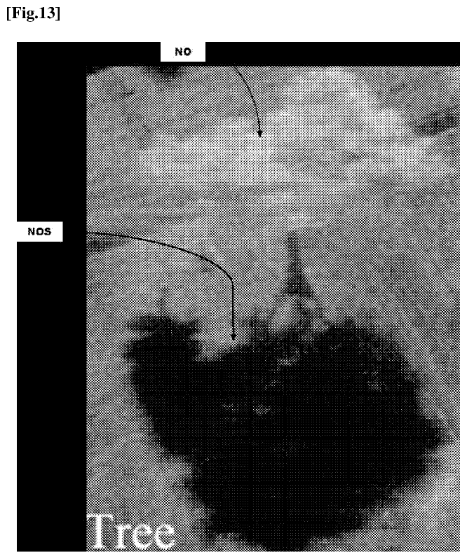

The artificial object can be understood as object with a high proportion of metals, etc., which have relatively low electromagnetic wave absorption and high reflectivity. Therefore, the artificial object can show relatively clear and distinct shapes in synthetic aperture radar images that use electromagnetic wave transmission and reception methods, allowing the type of object to be distinguished. (See FIG. 12)

On the other hand, an object with relatively low electromagnetic wave reflectivity, where at least part of the electromagnetic waves penetrate (or absorb), can be defined as a natural object.

Here, the natural object can be understood to have a significantly lower backscattering coefficient of electromagnetic waves compared to the artificial object.

Also, the natural object with relatively low reflectivity can be understood as an object with high absorptivity.

The natural object has characteristics contrasted with the artificial object that can be clearly identified in the synthetic aperture radar image.

The natural object may include a living thing. Therefore, the natural object may appear as a shape, line, point, etc. that is difficult to clearly identify in the synthetic aperture radar image due to its relatively high electromagnetic wave absorption. In other words, the natural object has low clarity and/or resolution in the synthetic aperture radar image, making it difficult to specify or distinguish the type of object.

For example, in the case of a tree in farmland, a synthetic aperture radar image may have difficulty clearly distinguishing or identifying the shape of the tree from the shape of the farmland. (See FIG. 13) For this reason, it may be difficult to calculate the size, height, growth direction, occupied area, etc. of the tree in farmland in the synthetic aperture radar image.

Of course, even if an electromagnetic wave can penetrate the natural object, it may reflect some electromagnetic waves due to the characteristics of electromagnetic waves having various wavelengths. However, the distinction between an artificial object and a natural object according to embodiments of the present invention can be set based on whether the shape of the corresponding object can be clearly identified in the synthetic aperture radar image according to the degree of reflection and absorption.

The processing module (20) can extract the shadow of the artificial object and the shadow of the natural object from the synthetic aperture radar image received by the receiver module (10).

The electromagnetic wave transmitted from the synthetic aperture radar to an artificial object and/or a natural object does not reach a surface due to reflection, absorption, etc. by an object on the surface, and the area of the surface where it does not reach appears as a shadow in the synthetic aperture radar image.

The shadow appears commonly for both an artificial object and a natural object, and even if there is a slight difference in the density of the shadow depending on the type of object, it does not affect identification. In other words, the processing module (20) can clearly identify and extract a shadow in a single synthetic aperture radar image.

The processing module (20) may include a moving target object processing module (100) that acquires information about a moving object among artificial objects in the image received by the receiver module (10).

The moving target object processing module (100) can determine an actual position of a moving object moving with velocity among the artificial objects based on the position of the extracted shadow.

In addition, the processing module (20) may include a natural object processing module (200) that distinguishes natural objects that absorb at least a part of electromagnetic waves. Meanwhile, the processing module (20) according to an embodiment of the present invention may selectively include either the moving target object processing module (100) and the natural object processing module (200), or may include both. A detailed description of the natural object processing module (200) will be described later.

The receiver module (10) may receive a level 1 (LEV.1) image of the synthetic aperture radar. Specifically, the receiver module (10) may acquire data converted into a two-dimensional level 1 (LEV.1) image through a series of signal processing of signals (i.e., raw data) collected by the synthetic aperture radar equipped on the carrier. Here, the signal collected by the synthetic aperture radar may be understood as a signal collected by a single synthetic aperture radar.

The moving target object processing module (100) may detect a moving object moving with velocity among artificial objects with high electromagnetic wave reflectivity based on the synthetic aperture radar level 1 image received by the receiver module (10).

The moving target object processing module (100) may acquire information such as the moving velocity, moving direction, and actual position of the moving object.

Since the moving object is defined as an artificial object moving with velocity, an artificial object with no velocity can be defined as a stationary object.

The processing module (20) can easily identify the shadow of the stationary object. This is because the shadow of the stationary object appears continuously connected to the relatively clear shape of the stationary object in the image. As will be described later, since the shape of the moving object appears shifted from its actual position in the image, the shape of the object and its shadow may appear separated. Meanwhile, natural objects generally have characteristics close to stationary objects with no velocity, that is, characteristics where the shadow and the shape of the object are continuously connected. However, there is a problem that the shape of the natural object is unclear and difficult to identify. Therefore, to solve the problem of separating the shape and shadow of the moving object described above and the problem of identifying due to the unclear shape of the natural object, the processing module (20) according to an embodiment of the present invention can perform the function of extracting and distinguishing the shadow of the corresponding object.

FIG. 2 is a diagram showing the configuration of the moving target object processing module of FIG. 1.

Referring to FIGS. 1 and 2, the moving target object processing module (100) may include a target setting unit (110).

The target setting unit (110) may perform a pre-filtering process to detect moving objects in the image received by the receiver module (10). This pre-filtering may also be referred to as “primary filtering”.

The level 1 image received from the receiver module (10) may show both stationary objects such as trees and buildings, as well as moving objects. Therefore, the target setting unit (110) may set moving objects, which are the targets for information acquisition, from the level 1 image.

Specifically, the target setting unit (110) may set a moving object (hereinafter, a moving target object) that is the target for information acquisition by detecting and/or distinguishing objects capable of movement from the received level 1 image.

Here, multiple moving target objects may be detected in the level 1 image. Therefore, when multiple moving target objects are detected, the target setting unit (110) may also set individual labeling so that each moving target object can become an individual reference point for acquiring information.

For example, the target setting unit (110) may distinguish objects that can have moving velocity from those that cannot in the level 1 image using a deep learning method with a multi-layer structure of input layer, hidden layer, and output layer. The target setting unit (110) may then individually extract or filter only the objects that can have moving velocity from the level 1 image.

Since the method of extracting movable objects and distinguishing them by type using deep learning in synthetic aperture radar (SAR) images is already a disclosed technology, a detailed explanation is omitted.

Here, objects that can have the moving velocity can be divided into objects that are actually moving and objects that are stationary. For example, a car is an object that can reflect electromagnetic waves and have moving velocity, but its moving velocity will be 0 when stationary. However, objects with moving velocity of 0 need to be excluded from the moving target object candidate group because they are not the target of information we want to acquire in the embodiment of the present invention. In this regard, objects capable of movement but with moving velocity of 0 may be excluded from the moving target object candidate group by the target-shadow matching unit processing to be described later.

As another example, the target setting unit (110) may set moving target objects by using a filtering method that removes objects having strong scattering (or backscattering coefficient) characteristics above a predetermined threshold. Since the processing method for detecting or removing fixed objects that cannot have moving velocity, such as buildings, roads, and trees, in synthetic aperture radar images is already a disclosed technology, a detailed explanation is omitted.

Additionally, the type of moving target object may be acquired in the pre-filtering process of the target setting unit (110). For example, when detecting the moving target object through an object detection method using deep learning, upper categories such as ships, warships, tanks, trucks, passenger cars, etc., and lower categories such as manufacturers and models can be distinguished and defined with labeling during the deep learning process for the types of moving target objects.

As described above, the moving object with velocity in the level 1 image received by the receiver module (10) may appear at an unrealistic position that is shifted from their actual position due to the Doppler effect.

The shadow that electromagnetic waves cannot reach due to the moving object, i.e., the shadow of the moving object, appears in the received level 1 image at the actual position of the moving object or with a very close association to the actual position, regardless of the Doppler effect. In other words, if the shadow of a moving object shifted to an unrealistic position can be found in the received level 1 image, the actual position of the moving object can be estimated.

However, in the synthetic aperture radar (SAR) level 1 image, multiple moving objects and multiple shadows generated by these multiple moving objects may appear mixed. Shadows caused by objects other than moving objects or by noise may also be visible.

Here, shadows of stationary objects may be removed in the pre-filtering process of the target setting unit (110) described earlier, as they appear connected to stationary objects with fixed positions.

Additionally, since the technology for filtering areas that may be mistaken for shadows formed by noise rather than shadows formed by moving objects in the synthetic aperture radar level 1 image is already a disclosed technology, a detailed explanation is omitted.

In other words, if multiple moving objects exist in a synthetic aperture radar (SAR) level 1 image capturing a specific area, the multiple moving objects will be shown at unrealistic positions rather than their actual positions. Therefore, if it can be determined which shadow belongs to each moving object in the level 1 image, the actual position of each moving object can be found in a single synthetic aperture radar level 1 image. And if the distance between the actual position and the unrealistic position of each moving object can be calculated, the moving velocity and direction of the moving object can be derived.

For this purpose, the moving target object processing module (100) may further include a boundary setting unit (120).

The boundary setting unit (120) may set a boundary within which the shadow of the moving target object set by the target setting unit (110) can be found. That is, the boundary setting unit (120) may set individual boundaries for each of the multiple moving target objects.

Specifically, the boundary setting unit (120) may set boundaries with variable sizes for each moving target object according to the maximum (Max) velocity of the moving target object set by the target setting unit (110). The boundary may be set using the following mathematical formula 1.

$$Δ = Rv / V \qquad [ Mathematical Formula 1 ]$$

Here, R is the distance between the moving object and the synthetic aperture radar (SAR) of the carrier, and V is the moving velocity of the SAR of the carrier. R and V are values that can be acquired in advance when receiving level 1 image data. The variable v is the maximum velocity of the moving target object, and Δ is the maximum position displacement.

To determine v, the boundary setting unit (120) may retrieve information about the maximum velocity based on the labeled type of moving target object set by the target setting unit (110). For example, the boundary setting unit (120) may load the maximum velocity for each type of moving target object pre-stored in a storage unit (not shown).

The pre-stored maximum velocities for each type of moving target object may be stored by subcategories according to upper categories such as tanks, trucks, passenger cars, etc. For example, the storage unit may store that tank model a of company A has a maximum velocity of 60 km/h, and passenger car model b of company B has a maximum velocity of 240 km/h.

The maximum position displacement (Δ) will be calculated as a value that varies according to the maximum velocity of the moving target object, since R and V values are already determined.

Meanwhile, one pixel of a synthetic aperture radar (SAR) level 1 image may consist of spatial resolution in the azimuth (or flight) direction and spatial resolution in the range (or wave propagation) direction.

For example, when R=850 km, V=7100 m/s, if the maximum velocity v of the moving target object is 15 m/s, the maximum position displacement (Δ) becomes about 1800 m. Therefore, if applied to an image with a spatial resolution of about 4 m in the azimuth direction and about 2 m in the range direction, a maximum of 450 pixel spaces are generated along the azimuth direction coordinate axis of the pixel, and a maximum of 900 pixel spaces are generated along the range direction coordinate axis of the pixel. Thus, the boundary for a moving target object with a maximum velocity of 15 m/s can be set to have 450 pixels toward the azimuth direction coordinate axis and 900 pixels toward the range direction coordinate axis.

Since the set boundary is an area formed by the maximum possible moving distance of the moving target object, the shadow of the moving target object must be located within the set boundary.

The moving target object processing module (100) may further include a target-shadow matching unit (130).

The target-shadow matching unit (130) may match moving target objects with shadows using a machine learning model within individual boundaries set by the boundary setting unit (120).

Specifically, the target-shadow matching unit (130) may include a machine learning model generation unit (131) that generates a machine learning model for finding shadows matching moving objects by generating and repeatedly learning shadow learning data of SAR level 1 images for each category of moving objects.

The machine learning model generation unit (131) may generate a machine learning model that achieves an F1-score of 0.8 or higher.

Additionally, the machine learning model may determine whether the moving target object is positioned in front of or behind the matched shadow based on the direction in which the SAR views the moving target object. This allows distinguishing whether the moving target object is moving forward or backward.

Furthermore, the machine learning model may acquire the angle (Aspect angle) between the direction in which the SAR views the moving target object and the direction in which the moving target object faces forward. This acquired angle (Aspect angle) may be named the ‘beta angle’. The beta angle can be used to calculate the moving velocity and direction of the moving target object.

A detailed explanation of the machine learning model generated by the machine learning model generation unit (131) will be described later with reference to FIG. 4.

The target-shadow matching unit (130) may further include a matching candidate verification unit (132) that verifies shadows matching moving target objects through the machine learning model generated by the machine learning model generation unit (131).

The matching candidate verification unit (132) may exclude the matched shadow and moving target object from the information acquisition target if the shadow matching the moving target object within the boundary set by the machine learning model appears as an image connected to the moving target object (or an image close within a preset error range).

As described above, objects with zero moving velocity do not appear at unrealistic shifted positions in the level 1 image. Therefore, it may be desirable from an information processing simplification perspective to exclude movable objects that have stopped with zero moving velocity from the moving target object candidate group.

Additionally, the matching candidate verification unit (132) may match a shadow with higher priority if multiple shadows show high matching possibility for one moving target object within the boundary set by the boundary setting unit (120).

For example, in the process of matching moving target objects with shadows in the target-shadow matching unit (130), multiple shadows may be detected that are judged to have a matching probability higher than a set threshold (e.g., 80%) for a moving target object within an individual boundary.

In this case, the matching candidate verification unit (132) may set priorities for the multiple detected shadows and complete the matching by matching the shadow with the highest priority to the moving target object.

First, the matching candidate verification unit (132) may check the matching results of other moving target objects and shadows proceeding in parallel, and exclude from priority setting any shadows among the multiple detected shadows that are matched to other moving target objects.

Then, among the multiple detected shadows that are not matched to other moving target objects, features satisfying a similarity and closeness setting value (e.g., 0.9) or higher with the moving target object may be selected, and priorities may be determined in order of having more of these selected features.

Here, the similarity and closeness with the moving target object may be pre-calculated and generated by the machine learning model generation unit (131) and stored in the storage unit. For example, during the machine learning model generation process, shadows of preset feature points (e.g., tank gun barrel shape) per unit pixel in moving target objects of the same category type may be extracted, and the similarity and closeness of the extracted shadows for the feature points among all shadows within the same category type may be normalized and stored.

Therefore, priorities can be determined based on how many extracted shadows satisfying the similarity and closeness setting value of 0.9 or higher are among the multiple detected shadows for a moving target object within the boundary.

According to this, even if multiple matchable shadows for a moving target object are detected due to environmental variables (e.g., other noise) that are difficult to predict in the level 1 image, matching accuracy and reliability can be improved by completing the matching with the shadow of the highest priority as described above.

The target-shadow matching unit (130) may further include a matching result acquisition unit (133) that acquires shadows matched and/or verified with moving target objects within the boundary set by the boundary setting unit (120) through the generated machine learning model.

Since shadow matching is confirmed for individual moving target objects, the matching result acquisition unit (133) can retrieve beta angle information of the moving target object based on the size and shape information of the matched shadow.

In the machine learning model generation process, shadows according to changes in the beta angle of the moving target object among SAR environment variables are all generated and used as learning data, so if a matching shadow is confirmed, the beta angle can be acquired in addition to the actual position of the moving target object and the distance between them.

Additionally, the matching result acquisition unit (133) can acquire the position of the front of the moving target object based on the beta angle (Aspect angle) of the matched moving target object.

Furthermore, the matching result acquisition unit (133) can determine the moving direction of the moving target object based on the acquired position.

Specifically, the matching result acquisition unit (133) can determine the moving direction of the moving target object as forward if the moving target object is positioned in front of the matched shadow based on the direction in which the SAR views the moving target object, and as backward if positioned behind.

The moving target object processing module (100) may further include a target information calculation unit (140).

The target information calculation unit (140) can calculate information about the moving target object based on the moving target object and shadow matched by the target-shadow matching unit (130).

Specifically, the target information calculation unit (140) can calculate the moving velocity (V moving velocity) of the moving target object using the following mathematical formula 2.

$${V}_{moving velocity} = \frac{{V}_{s} Δ D}{R cos ( β )} \qquad [ Mathematical Formula 2 ]$$

Here, to calculate the moving velocity (V moving velocity) of the moving target object, Vs is the velocity of the synthetic aperture radar (SAR) of the carrier, ΔD is the distance between the matched shadow and the moving target object, R is the distance between the SAR of the carrier and the moving target object, and cos(β) is the horizontal reference value for the angle at which the moving target object is facing based on the direction in which the SAR views the moving target object (i.e., the range direction), where the angle β is the aforementioned beta angle (Aspect angle).

Additionally, Vs and R are values already acquired when receiving the level 1 image, and cos(β) can be input since the beta angle for the moving target object can be obtained through the matching completion by the target-shadow matching unit (130).

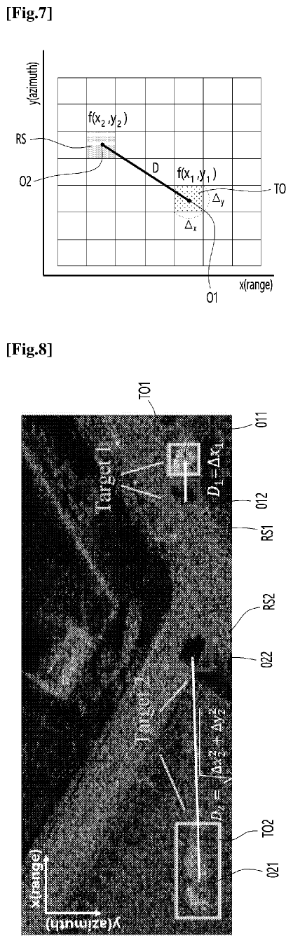

Meanwhile, the distance between the shadow and the moving target object (ΔD) can be calculated by reflecting different scales for each axis direction of pixels according to the Range direction spatial resolution and Azimuth direction spatial resolution, as explained in the boundary setting description above. A detailed explanation related to this will be described later with reference to FIGS. 7 and 8.

As a result, the target information calculation unit (140) can calculate and/or provide information on the moving velocity and moving direction at the actual position of the moving target object.

Meanwhile, the object information detection system (1) based on synthetic aperture radar images according to an embodiment of the present invention may further include a correction module (30) and an output module (40) for processing into Level 2 and/or Level 3 images.

For example, the correction module (30) can correct the synthetic aperture radar (SAR) image based on information such as the moving velocity, moving direction, and shifted position of the moving object acquired by the moving target object processing module (100).

Specifically, since the correction module (30) can determine the actual position of the moving object by the moving target object processing module (100), it can correct the moving object at a shifted unrealistic position in the SAR image to its actual position.

Additionally, after correcting the moving object to its actual position by the moving target object processing module (100), the correction module (30) can perform at least one of geometric and radiometric corrections. For example, the correction module (30) can perform a process to correct noise such as orbit and thermal terrain.

In other words, the correction module (30) can utilize and reprocess the results acquired by the moving target object processing module (100).

The output module (40) can perform the function of outputting the information acquired by the moving target object processing module (100) and/or the image corrected by the correction module (30).

For example, the output module (40) can transmit the acquired information and/or corrected image externally.

As another example, the output module (40) can transmit the Level 1 image to a user terminal, and when the cursor is positioned on a shifted moving object on the user terminal, it can display the actual position (shadow position), moving velocity, and moving direction information.

In other words, the correction module (30) and output module (40) are configured to utilize the result values of the moving target object processing module (100) to provide various services based on the image acquired from a single synthetic aperture radar.

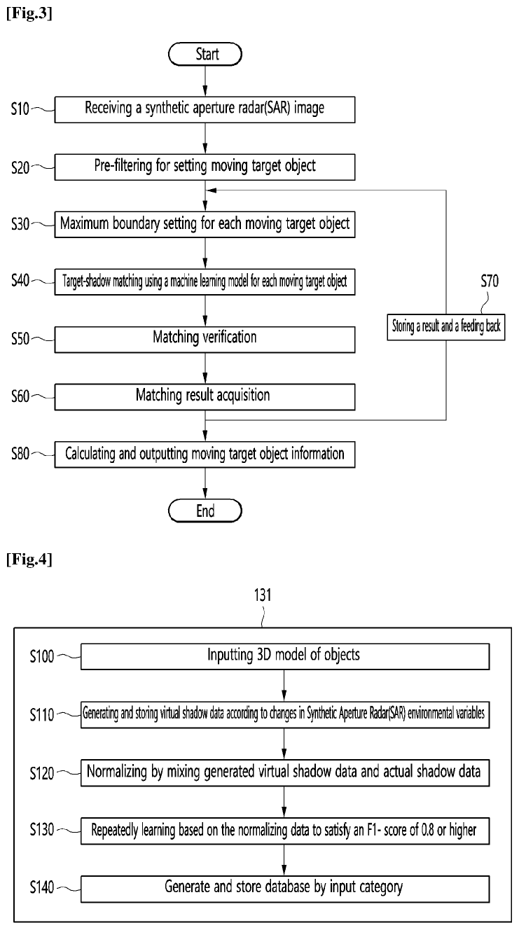

Hereinafter, a method for acquiring information such as moving velocity of a moving object based on a single synthetic aperture radar (SAR) image will be described in detail with reference to FIGS. 3 to 8.

FIG. 3 is a flow chart showing a method for detecting moving object information based on a synthetic aperture radar image according to an embodiment of the present invention.

Referring to FIG. 3, the method for detecting moving object information based on a synthetic aperture radar (SAR) image according to an embodiment of the present invention can perform a step (S10) of receiving an image (for example, a Level 1 image) through the receiver module (10).

Additionally, a pre-filtering step (S20) for setting moving target objects can be performed in the received image (Level 1 image). The pre-filtering step (S20) can be performed by the target setting unit (110) of the moving target object processing module (100). As described above, the pre-filtering step (S20) can be understood as a process of extracting movable objects from the received image (Level 1 image) and setting moving target objects. For a detailed explanation related to this, the description of the target setting unit (110) is referenced.

The moving target objects set by the pre-filtering step (S20) can be assumed to have velocity. If a stationary moving target object with zero velocity is set, it can be filtered out and removed from the target during the matching candidate verification process of the target-shadow matching unit (130) as described above. Additionally, multiple moving target objects can be set.

When moving target objects are set, a boundary setting step (S30) based on the maximum velocity of the moving target objects can be performed.

The boundary can be set by the boundary setting unit (120) described above.

If multiple moving target objects are set, multiple boundaries can be set based on the maximum velocity for each moving target object. Therefore, the size of the boundary can vary depending on the moving target object.

When boundary setting is completed, a target-shadow matching step (S40) using a machine learning model for each moving target object can be performed.

The target-shadow matching step (S40) using the machine learning model can be performed by the target-shadow matching unit (130). Additionally, a machine learning model can be generated in the machine learning model generation unit (131) and used to perform matching between moving target objects and shadows.

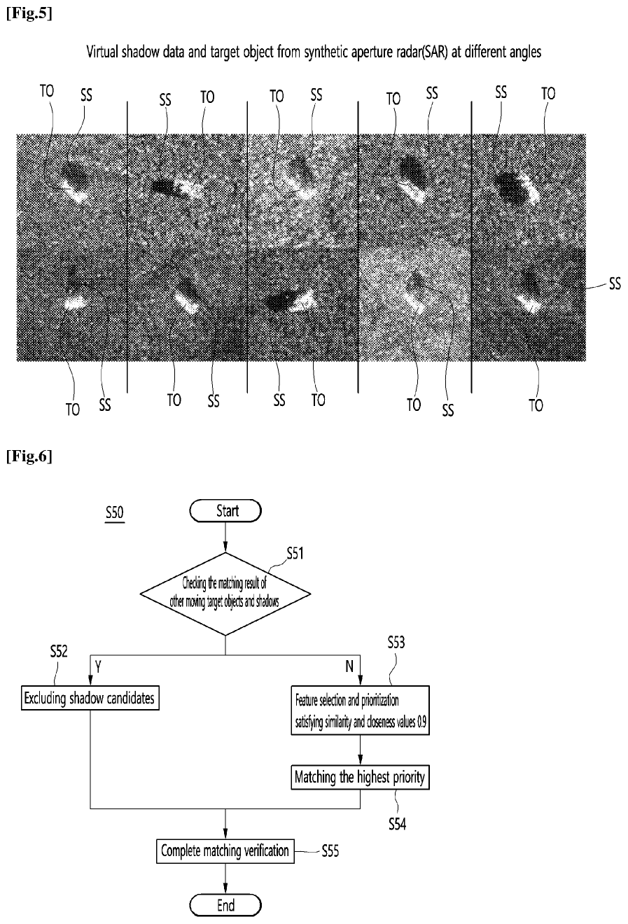

Hereinafter, the target-shadow matching step (S40) using the machine learning model will be described in detail with reference to FIGS. 4 and 5. FIG. 4 is a flow chart showing a machine learning model according to an embodiment of the present invention, and FIG. 5 is a diagram showing virtual shadow images generated for each angle of an object in the machine learning model of FIG. 4.

Generally, due to the difficulty of possessing and operating carriers (satellites, aircraft, drones, etc.) equipped with synthetic aperture radar (SAR), it is challenging to generate and secure learning data for studying the characteristics of objects appearing in SAR images. For example, the types of moving objects with high electromagnetic wave reflectivity operating on land and sea are relatively vast. It is realistically very difficult to acquire SAR images with shadows applying all environmental variables for each type of moving object individually.

To address this, the machine learning model according to an embodiment of the present invention can generate virtual shadow learning data by simulating changes in SAR environmental variables. The machine learning model can repeatedly perform normalization by mixing the virtual shadow learning data with actual shadow data acquired through real SAR images. The machine learning model is defined to satisfy an F1-score of 0.8 or higher based on the repeated normalization.

Referring to FIG. 4, the machine learning model generation unit (131) may have a step (S100) of inputting 3D models of objects by category for generating the aforementioned virtual shadow data.

Here, the object is explained based on a moving object with high electromagnetic wave reflectivity that can have moving velocity. The explanation of machine learning model generation for natural objects will be described separately later.

The category can be defined to be sequentially distinguished from upper to lower levels. For example, the highest upper category may be ships operating at sea and vehicles operating on land. The lower category of ships can be defined as cruise ships, oil tankers, yachts, military destroyers, aircraft carriers, etc. The lower category of vehicles can be defined as trucks, passenger cars, forklifts, tanks, armored vehicles, self-propelled artillery, etc. The passenger cars can be further defined into lower categories of small, medium, and large cars. The medium cars can be further defined into lower categories by manufacturer and model year.

For example, the 3D model can be input as a 3D shape according to the manufacturer and model year model, which is the lowest category among the categories.

The method may have a step (S110) of generating and storing virtual shadow data according to changes in SAR environmental variables based on the input 3D model.

Here, the SAR environmental variables may include frequency, band, synthetic distance, incidence angle, model position, etc. The virtual shadow data can be generated by simulation combining all cases of changes in the SAR environmental variables.

For example, based on the input 3D model, virtual shadows generated by minutely changing the position of the 3D model in all directions can be extracted and stored, using the direction in which the SAR views the 3D model as a reference point.

Referring to FIG. 5, virtual shadows (SS) generated by changing the position angle of an object (TO) in a certain state can be extracted, based on the direction the synthetic aperture radar is looking. The virtual shadows (SS) generated for each change angle (environmental variable) can be matched with the angle information of the object and stored in a storage unit.

Here, virtual shadow data can be generated according to the angle (that is, beta angle) formed between the front direction of the 3D object and the direction the synthetic aperture radar is looking at the object.

Meanwhile, the method of constructing a simulation system that generates synthetic aperture radar (SAR) simulated received signals to acquire virtual SAR images of specific ground objects, analyzes them, and acquires images is disclosed in the aforementioned prior art document, so a detailed explanation will be omitted.

Additionally, in the process of generating virtual shadow data, feature points can be extracted by projecting the 3D object into 2D and dividing it into cells, and virtual shadow data corresponding to the extracted feature points can also be generated and stored. The stored virtual shadow data can be used to distinguish between objects in the same lower category. For example, if unique characteristics of a specific model are acquired among the shadows of feature points for divided cells in the lowest category, it can be ranked relatively high in a normal distribution table that can compare similarity and closeness.

Meanwhile, if repeated learning is performed only with the generated and stored virtual shadow data, the possibility of distorting information and judging incorrect shadow images as true (related to reliability) may become relatively high.

To prevent this, the machine learning model according to an embodiment of the present invention may have a normalizing step (S120) of mixing virtual shadow data generated for each combination of environmental variable changes as well as actual shadow data acquired by real synthetic aperture radar (SAR) images at a predetermined ratio.

Here, the mixing ratio of virtual shadow data to actual shadow data can be defined as a maximum of 8:2. This allows reliability to be improved because the machine learning model can learn by repeatedly comparing actual shadow data with virtual shadow data at a certain ratio.

Additionally, the machine learning model according to an embodiment of the present invention may have a step (S130) of repeatedly learning based on the normalizing data to satisfy an F1-score of 0.8 or higher.

The F1-score is defined as the harmonic mean of precision and recall as a method for evaluating the reliability of the machine learning model.

The F1 score can be understood as a formula expression of a confusion matrix that indicates what type of matching the actual label class value and the predicted label class value have.

For example, the confusion matrix can be expressed as a formula [T(true)P(positive)+T(true)N(negative)]/Total. Here, precision defines how accurate the predicted value is as the ratio of actual positives among cases predicted as positive ([TP/(TP+FP)]), and recall is defined as how well the actual correct answers were matched as the ratio of correctly matched positives among actual positives.

In other words, the machine learning model according to an embodiment of the present invention can repeatedly learn while performing repeated normalizing with the maximum ratio of the normalizing data limited until the F1-score finally becomes 0.8 or higher.

When the F1-score satisfies 0.8 or higher, the machine learning model according to an embodiment of the present invention can generate a shadow database for objects by upper-lower categories as described above and store information such as beta angles for each shadow (S140).

Meanwhile, in the target-shadow matching step (S40) using the machine learning model, most moving target objects are matched with shadows within the boundary, but since the matching step is performed in parallel, identical/similar shadows that can be matched as shadows of moving target objects may appear in multiple within one boundary due to moving target objects being the same model or other environmental noise.

In this case, a matching verification step (S50) can be performed to complete matching with high reliability. Additionally, the matching verification step (S50) can be performed by the matching candidate verification unit (132).

FIG. 6 is a flow chart showing in detail the matching verification step among the methods for detecting moving object information based on a synthetic aperture radar image according to an embodiment of the present invention. The matching verification step (S50) is explained in detail with reference to FIG. 6.

In the matching verification step (S50), when a shadow matching the moving target object appears as an image connected to the moving target object (or an image close within a preset error range) within the boundary set by the machine learning model, the matched shadow and moving target object may be excluded from the information acquisition target as described above.

Additionally, when multiple shadows show a high possibility of matching for one moving target object within the set boundary, a step of checking the matching results of other moving target objects and shadows proceeding in parallel is performed. (S51)

If there is a shadow matched to another moving target object among the multiple shadows, that shadow is excluded from the matching priority. (S52)

If there are shadows among the multiple shadows that are not matched to other moving target objects proceeding in parallel, features satisfying a similarity and closeness setting value (e.g., 0.9) or higher with the moving target object are selected, and priority is set and sorted in order of having more of the selected features. (S53)

Here, the similarity and closeness with the moving target object can be generated together in the machine learning model generation process and stored as a table in the storage unit as described above.

For example, in the machine learning model generation process, shadows of preset feature points (e.g., tank gun barrel shape) per unit pixel in moving target objects of the same category type can be extracted, and the similarity and closeness of the extracted shadows for the feature points among all shadows within the same category type can be normalized and stored.

Therefore, the priority can be determined based on how many extracted shadows satisfying the similarity and closeness setting value of 0.9 or higher are among the multiple shadows for the moving target object within the boundary.

The shadow with the highest priority among the determined priorities is matched with the moving target object. (S54)

Thereby, when multiple matchable shadows are presented after excluding movable objects with zero velocity, shadows matching other moving target objects are removed from the boundary, and matching verification is completed by matching the shadow with the highest priority to the moving target object based on the aforementioned priority. (S55)

When the target-shadow matching step (S40) using the machine learning model for each target object and/or the matching verification step (S50) is completed, a matching result acquisition step can be performed to load information such as beta angle information and front/rear information of the moving target object based on the matched moving target object and shadow. (S60)

The matching result acquired here may include the beta angle of the moving target object, the direction the front of the moving target object is facing, the actual position of the moving target object (i.e., the part connected to the matched shadow), and the distance between the matched shadow and the shape of the moving target object shifted to an unrealistic position.

Meanwhile, after step S60 is completed, a step (S70) of storing the results such as the matched shadow and moving target object information and feeding it back to the boundary setting step (S30) may be performed. This allows for faster information processing as shadows and moving target objects that have already been matched are excluded from analysis targets, and matching results performed in parallel can be reflected in real-time to speed up shadow matching of moving target objects and improve reliability of matching results.

Based on the acquired matching results, a step of calculating and outputting moving target object information using the aforementioned mathematical formula 2 can be performed. (S80)

The information calculated in step S80 may include the moving velocity for each moving target object. In addition, the level 1 image can be reprocessed with the calculated moving velocity, moving direction, and actual position of the moving target object through the correction module (30) and output module (40) described above, and output externally.

FIG. 7 is a diagram exemplarily explaining the concept for calculating the distance between a moving target object and a shadow within a boundary according to an embodiment of the present invention, and FIG. 8 is a diagram exemplarily showing the calculation of information between a moving target object and a matching shadow in a level 1 image of a single synthetic aperture radar according to an embodiment of the present invention.

Referring to FIG. 7, one pixel (square) can be understood as a horizontal distance (Δx) along the range direction x-axis by the range direction spatial resolution and a vertical distance (Δy) along the azimuth direction y-axis by the azimuth direction spatial resolution.

Here, the distance (D) between the center point (O1) of the moving target object (TO) at a shifted unrealistic position and the center point (O2) of the shadow (RS) matched to the moving target object is given by the following mathematical formula 3.

$$D = \sqrt{{( {x}_{1} - {x}_{2} )}^{2} Δ x + {( {y}_{2} - {y}_{1} )}^{2} Δ y} \qquad [ Mathematical Formula 3 ]$$

For example, if applied to an image with an azimuth direction spatial resolution of about 4 m and a range direction spatial resolution of about 2 m, the horizontal distance (Δx) of one pixel is 2 m, and the vertical distance (Δy) is 4 m. Therefore, the distance (ΔD) between the shadow and the moving target object in the aforementioned mathematical formula 2 can be calculated in meters.

Referring to FIG. 8, a shadow of a moving object and a shifted shape of the moving object at an unrealistic position can be seen in the synthetic aperture radar (SAR) level 1 image.

Specifically, to the left of the moving target object (TO1) with velocity is located the shadow (RS1) matched by the target-shadow matching module (130).

Here, based on the synthetic aperture radar viewing the moving target object, the moving target object (TO1) can be interpreted as advancing in the front direction (right direction) based on its shifted position to the right compared to the matched shadow. At this time, it can be seen that the distance (D1) between the moving target object (TO1) and the matched shadow (RS1) is calculated as Δx1 since only the horizontal component (range direction component) exists.

Meanwhile, another moving target object (TO2) with velocity appears at a position shifted to the lower left of the shadow (RS2) matched by the target-shadow matching module (130).

Here, the other moving target object (TO2) can be interpreted as advancing to the left based on its front direction (left) and shifted position to the left compared to the matched shadow (RS2). At this time, the distance (D2) between the moving target object (TO2) and the matched shadow (RS2) can be calculated as the root value of the sum of the squared pixel distance difference in the range direction (reflecting spatial resolution) and the squared pixel distance difference in the azimuth direction (reflecting spatial resolution).

Since it is difficult to calculate an accurate beta angle in the level 1 image by simply identifying the front or rear direction of the moving target object, a more precise and accurate beta angle can be obtained based on the information of the matched shadow (R1, R2) in the target-shadow matching module (130) as described above.

Eventually, the moving velocity (V) of each object can be calculated using mathematical formula 1 through the distance (D1, D2) between the moving target objects (TO1, TO2) and their matched shadows (RS1, RS2), and the beta angle.

Meanwhile, as described above, the processing module (20) may include a natural object processing module (200) that distinguishes natural objects that absorb at least a part of electromagnetic waves.

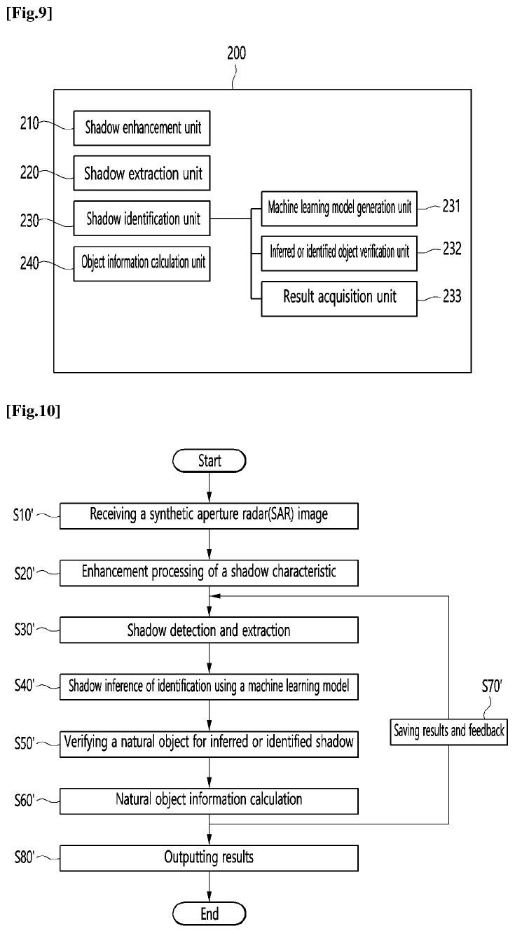

FIG. 9 shows the configuration of the natural object processing module of FIG. 1.

Referring to FIG. 9, the natural object processing module (200) can acquire information about the natural object that is the source forming the extracted shadow using the shadow extracted from the image received by the receiver module (10).

In other words, the natural object processing module (200) can extract and identify shadows of natural objects that at least partially allow electromagnetic waves to penetrate based on the image acquired through the receiver module (10).

For precise and effective extraction of shadows of natural objects, image or signal processing may be needed to distinguish and extract only shadows from the received image. Additionally, due to the penetration characteristics of electromagnetic waves, the shadows formed by natural objects may be enhanced to facilitate easier extraction and identification of natural object shadows.

Therefore, the natural object processing module (200) may include a shadow enhancement unit (210). The shadow enhancement unit (210) can be understood as a process of enhancing the characteristics of shadows for natural objects.

For example, the shadow enhancement unit (210) can process the received image so that “shadows” formed as shaded areas where electromagnetic waves cannot reach appear more clearly and distinctly.

For this, the shadow enhancement unit (210) can use filtering techniques for signal or image processing. For example, the shadow enhancement unit (210) can enhance shadow characteristics such as shadow clarity using techniques like multi-look with median filter or shortening the synthesis interval to increase shadow resolution.

Additionally, the shadow processing module (200) may further include a shadow extraction unit (220).

The shadow extraction unit (220) can perform filtering to detect and extract shadows from the image received from the receiver module (10) (for example, a level 1 image). For example, the shadow extraction unit (220) can perform filtering to exclude artificial objects and their shadows from extraction targets in the received image.

The shadow extraction unit (220) can search for and/or detect shadows that have no visible source or shadows with a weak visible source that is difficult to distinguish from the received image.

Here, the visible source can be understood as a source object visually seen in the received image to form a shadow.

Additionally, a shadow with a weak visible source that is difficult to distinguish can be understood as one where the existence or shape of a natural object cannot be clearly distinguished from the shadow in the received image without separate processing.

The shadow extraction unit (220) can determine shadows with a visible source to be shadows of artificial objects, and exclude them from detection or extraction targets. Of course, if a natural object can be clearly identified in the received image, the shadow of that natural object may also be excluded from extraction targets. This is because there is no need to extract shadows where the shape of the natural object can be clearly identified.

In other words, for simplification of information processing, the shadow extraction unit (220) can perform filtering to extract remaining shadows excluding shadows with clear visible sources.

As described above, the natural object may be difficult to meaningfully identify or distinguish as a visible source in the received image. Therefore, shadows without a visible source or with a weak visible source in the received image are likely to be natural objects that are difficult to distinguish from the received image alone.

For reference, referring to FIGS. 12 and 13, it can be seen that a tree (NO), which is a natural object, appears in a state that is relatively difficult to identify its shape compared to an aircraft (MO), which is an artificial object, from a synthetic aperture radar level 1 image.

The shadow extraction unit (220) can search for shadows without visible sources by applying a window with variable size within the received image. For example, the window can apply a 3 by 3 size for convenience of shadow searching according to the size of natural objects, and search for shadows without visible sources while sequentially decreasing or increasing the size.

Additionally, the shadow extraction unit (220) can individually divide or classify shadows determined or detected to have no or weak visible sources. The individual shadow classification method of the shadow extraction unit (220) can be based on length, area, etc.

For example, if multiple shadows with no or weak visible sources are detected in a level 1 image, labeling for information acquisition can be assigned and stored in a storage unit (not shown) according to a preset classification method for each shadow.

Furthermore, the shadow extraction unit (220) can distinguish shadows of objects with visible sources from shadows with no or weak visible sources from the level 1 image using a deep learning method with a multi-layer structure of input layer, hidden layer, and output layer.

The object with the visible source and its shadow can be filtered out from the level 1 image. The method of extracting objects and distinguishing them by type using deep learning in the level 1 image is already disclosed technology, so a detailed explanation is omitted.

Additionally, since multiple shadows generated by multiple objects are mixed in the level 1 image, the shadow extraction unit (220) may need to remove noise shadows caused by various environmental variables. The technology for filtering shadow misidentification areas formed by noise rather than shadows formed by objects in the level 1 image is already disclosed technology, so a detailed explanation is omitted.

The shadow detected and individually extracted by the shadow extraction unit (220) is likely to be a shadow of a natural object.

Therefore, the natural object processing module (200) needs to determine whether the individually extracted shadow is formed by a natural object.

For this purpose, the natural object processing module (200) may further include a shadow identification unit (230) that identifies what natural object the detected shadow is using a machine learning model.

The shadow identification unit (230) can infer and/or identify what natural object could form the shadow using a machine learning model from the individually extracted shadow.

For example, the shadow identification unit (230) can provide the natural object with the highest accuracy score (a value obtained based on shadow characteristics to be described later) among natural object candidates that could have one shadow with no or weak visible source extracted by the shadow extraction unit (220).

Specifically, the shadow identification unit (230) can generate a machine learning model that repeatedly learns by generating shadow learning data of level 1 images for natural objects classified by category. The machine learning model can infer and/or identify natural objects that can create the shadow based on a specific shadow.

For this purpose, the shadow identification unit (230) may include a machine learning model generation unit (231). Hereinafter, the explanation of the machine learning model generation unit (231) can be understood as a machine learning model for identifying natural objects.

The machine learning model of the shadow identification unit (230) can also identify shadows that a specific natural object can create in reverse order.

In summary, the shadow identification unit (230) can infer and/or identify the natural object forming the shadow extracted by the shadow extraction unit (220) using the machine learning model generated by the machine learning model generation unit (231).

The machine learning model can repeatedly learn about a shadow of the certain natural object characteristic or a characteristic of a shadow that the certain natural object may has.

Additionally, if the shadows of the natural object characteristic or the shadow characteristic of the natural object are judged to be above a similarity setting value (e.g., standard 0.7) with shadows for characteristics of other natural objects, the machine learning model can classify those characteristics as lower priority characteristics. Therefore, the machine learning model can set the priority of applicable characteristics when inferring natural objects from specific shadows.

The shadow identification unit (230) can determine the presence or absence of natural objects inferred and/or identified through the machine learning model using the characteristics of individually extracted shadows.

Additionally, the machine learning model generation unit (231) can generate a machine learning model that achieves an F1-score of 0.8 or higher.

Additionally, the machine learning model can determine whether the object is located in front of or behind the shadow based on the direction in which the synthetic aperture radar views the natural object.

Additionally, the shadow identification unit (230) can load the types of inferred and/or identified natural objects by category from a pre-stored machine learning model repository. Here, the category can be classified into large, medium, and small classifications.

For example, the large classification can be set as human body, plant, animal, etc. If the large classification is plant, the medium classification can be set as seed plant, spore plant, gymnosperm, angiosperm, etc., and the small classification can be set as lower plant names.

Additionally, the shadow identification unit (230) may further include an inferred or identified object verification unit (232) for verifying the natural object forming the individually inferred and/or identified shadow.

The inferred or identified object verification unit (232) can cross-verify whether the natural object for the shadow inferred and/or identified by the machine learning model exists at the corresponding location coordinates using public data.

For example, the inferred or identified object verification unit (232) can receive publicly available data such as SAR satellite images from different orbits, RGB satellite images, aerial images, etc. for the coordinates of the natural object for the shadow through network communication means. Therefore, it can cross-verify whether the natural object inferred and/or identified by the machine learning model is actually located at the corresponding coordinates.

The cross-verification result can be stored and fed back to the machine learning model generation unit (231).

As the true value according to the cross-verification of the inference or identification object verification unit (232) increases, and as the amount of feedback input by the inference or identification object verification unit (232) increases, the accuracy and reliability of the natural object inferred and/or identified by the shadow identification unit (230) will improve.

Meanwhile, the inference or identification object verification unit (232) can record and evaluate the performance of inference about natural objects among the shadows learned in the machine learning model generation unit (231).

For example, if a natural object inferred by the machine learning model is determined to be inaccurate or false, the inference or identification object verification unit (232) can re-evaluate and re-learn the characteristics of that shadow for inferring natural objects, and quantify and store the performance for the determined category.

Additionally, the inference or identification object verification unit (232) can perform a cross-verification process for lower-ranking categories with relatively low performance in inferring natural objects from shadows by the machine learning model. For example, the lower-ranking performance can be set as the bottom 10%.

This allows the inference ability for natural objects with various types to be improved as the amount of learning of the machine learning model increases, and the reliability can be enhanced by complementing, re-evaluating and re-learning the result values from the initial machine learning model.

Also, the shadow identification unit (230) may further include a result acquisition unit (233) that acquires the result of natural objects inferred and/or identified from shadows by the machine learning model.

The result acquisition unit (233) can calculate information about the natural object based on the size and shape information of the shadow, since the identification of the natural object for the shadow has been determined.

Additionally, the result acquisition unit (233) can acquire the actual direction or beta angle of the determined natural object from the shadow, since shadows for changes in beta angle of natural objects among synthetic aperture radar environmental variables are all generated and used as learning data in the machine learning model generation process.

The result acquisition unit (233) can also acquire positional information of the natural object based on the beta angle (Aspect angle) of the natural object.

The natural object processing module (200) may further include an object information calculation unit (240).

The object information calculation unit (240) can calculate information about the natural object based on the natural object identified by the shadow identification unit (230) and/or the shadow.

For example, the object information calculation unit (240) can calculate the height (or elevation), size, etc. of the identified natural object based on information such as the length, size, occupied area, etc. of the shadow.

Meanwhile, the correction module (30) and output module (40) can be provided to reflect the identified natural object as described above.

For example, the correction module (30) can process the synthetic aperture radar image into level 2 and/or level 3 images by reflecting the natural object identified by the shadow.

Additionally, the correction module (30) can correct the synthetic aperture radar image based on information such as height, size, position, etc. of the natural object identified by the shadow processing module (20). For example, since the correction module (30) can determine the position and size of the natural object identified by the natural object processing module (200), it can correct the synthetic aperture radar image to reflect the actual specifications of the natural object.

Also, the correction module (30) can also perform at least one of geometric and radiometric corrections along with the natural object identified by the natural object processing module (200). For example, the correction module (30) can perform a process to correct noise such as orbit and thermal terrain.

In other words, the correction module (30) can utilize and reprocess the results acquired by the natural object processing module (200).

The output module (40) can perform the function of outputting the information acquired by the natural object processing module (200) and/or the image corrected by the correction module (30). For example, the output module (40) can transmit the SAR image corrected by the correction module (30) externally.

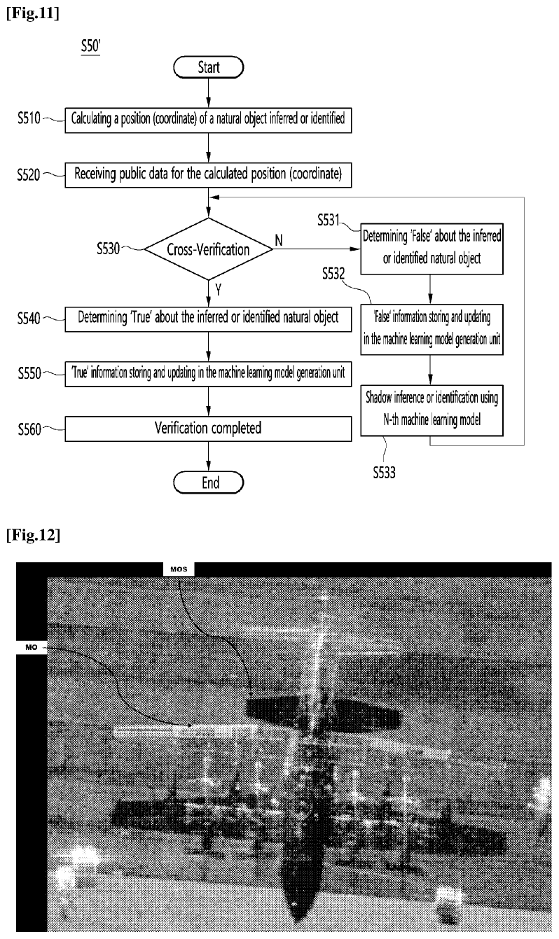

FIG. 10 is a flow chart showing a method for detecting natural object information based on a synthetic aperture radar image according to an embodiment of the present invention.

Referring to FIG. 10, the method for detecting natural objects based on a synthetic aperture radar (SAR) image according to an embodiment of the present invention may perform a step (S10′) of receiving a synthetic aperture radar image through a receiver module (10). For example, the synthetic aperture radar image may be a level 1 image.

Additionally, a shadow characteristic enhancement processing step (S20′) may be performed to enhance shadow characteristics in the received image.

The shadow characteristic enhancement processing step (S20′) may be performed by the shadow enhancement unit (210). The shadow enhancement unit (210) may enhance the signal or image of shadows of natural objects that have relatively light shaded areas due to some wavelengths of the synthetic aperture radar's electromagnetic waves reaching them.

The shadow characteristic enhancement processing step (S20′) can be understood as a process of enhancing shadow characteristics through image or signal filtering techniques to extract shadows following the above definition from the level 1 image.

Additionally, a shadow detection and extraction step (S30′) may be performed on the received image. The shadow detection and extraction may be performed by the shadow extraction unit (220).

As described above, the shadow extraction unit (220) may detect and extract only shadows without visible sources or shadows with weak or unclear visible sources.

In other words, the shadow detection and extraction step (S30′) can be understood as a step of filtering shadows that natural objects can form in the received image, excluding artificial objects.

Additionally, a shadow inference or identification step (S40′) may be performed to identify natural objects using a machine learning model from the individually detected and extracted shadows.

The shadow inference or identification step (S40′) using the machine learning model may be performed by the shadow identification unit (230).

In this S40′ step, a machine learning model can be generated in the machine learning model generation unit (231) described above, and natural objects can be inferred and/or identified from extracted shadows using the generated machine learning model. In other words, a natural object can be inferred or identified and matched from one shadow.

Meanwhile, referring to FIG. 4, a machine learning model for shadow inference or identification related to step S40′ will be explained. The machine learning model for inferring or identifying shadows of natural objects to be described below has the same technical concepts applied in each step, except that the target object has changed from a moving object to a natural object. Therefore, for matters equivalent to the machine learning model for distinguishing shadows of moving objects described earlier, the previous explanation is incorporated by reference.

Briefly, the machine learning model for shadow inference or identification to distinguish natural objects can use virtual shadow learning data generated by simulating changes in synthetic aperture radar environmental variables. The machine learning model can repeatedly perform normalization by mixing the virtual shadow learning data with actual shadow data acquired through real synthetic aperture radar (SAR) images. The machine learning model can be defined to satisfy an F1-score of 0.8 or higher based on the repeated normalization.

Specifically, the machine learning model generation unit (231) can input 3D models of natural objects that allow at least partial penetration of electromagnetic waves by category to generate virtual shadow data. (See step S100)

Here, the category can be defined to be sequentially distinguished from upper to lower levels. For example, the highest upper category may include animals, plants, human bodies, etc. The lower category of animals can be defined as mammals, reptiles, fish, etc., and the lower category of plants can be defined as seed plants, spore plants, etc. as described above.

Additionally, from the lower categories, names and characteristics of individual animals and plants can be defined as sub-classifications.

Furthermore, a step of generating and storing virtual shadow data according to changes in synthetic aperture radar (SAR) environmental variables based on the input 3D models can be performed. (See step S110)

In other words, shadows (SS) generated by changing the position angle of a specific object (TO) in a certain state can be extracted and stored based on the direction the synthetic aperture radar is looking.

Additionally, in the process of generating virtual shadow data, feature points can be extracted by projecting the 3D object into 2D and dividing it into cells, and virtual shadow data corresponding to the extracted feature points can also be generated and stored. The stored virtual shadow data can be used to distinguish between objects in the same lower category. For example, if unique characteristics of a specific natural object are acquired among the shadows of feature points for divided cells in the lowest category, it can be acquired with a high similarity and closeness score for natural objects that can be inferred from the shadow, and may be prioritized in the inference result ranking.

Meanwhile, if repeated learning is performed only with the generated and stored virtual shadow data, the possibility of distorting information and judging incorrect shadow images as true (related to reliability) may become relatively high. To prevent this, the machine learning model according to an embodiment of the present invention may have a normalizing step of mixing virtual shadow data generated for each combination of environmental variable changes as well as actual shadow data acquired by real synthetic aperture radar (SAR) images at a predetermined ratio. (See step S130)

Additionally, the machine learning model according to an embodiment of the present invention may have a step of repeatedly learning based on the normalizing data to satisfy an F1-score of 0.8 or higher. (See step S140)

When the F1-score satisfies 0.8 or higher, the machine learning model according to an embodiment of the present invention can generate a shadow database for objects by upper-lower categories as described above and store information such as beta angles for each shadow.

Meanwhile, in the shadow identification step (S40′) using the machine learning model, most extracted shadows can be matched with inferred or identified natural objects, but as a method to increase reliability of initial learning data and remove noise, a step (S50′) of verifying whether the inferred or identified natural object is correct can be further performed.

The verification step (S50′) can be performed by the inference or identification object verification unit (232).

FIG. 11 is a flow chart showing in detail the step of verifying natural objects among the methods for detecting natural object information based on a synthetic aperture radar image according to an embodiment of the present invention.

Referring to FIGS. 10 and 11, the verification method of step S50′ includes a step (S510) of calculating the position of a natural object inferred or identified from a shadow by the machine learning model. The position of the natural object can be provided as coordinates.

The method may include a step (S520) of receiving public data for the calculated position (coordinates) through communication means. For example, the public data may include SAR satellite images from different orbits, RGB satellite images, aerial images, and the most recently updated Geographic Information System (GIS) information.

Also, cross-verification can be performed to determine if the inferred or identified natural object exists at the coordinates of the received public data. (S530)

If the inferred or identified natural object is determined to be true through the cross-verification (S540), the information determined to be true can be stored and updated in the machine learning model generation unit (231). (S550)

As the true value according to the cross-verification of the inference or identification object verification unit (232) increases, and as the amount of feedback input by the inference or identification object verification unit (232) increases, the accuracy and reliability of the natural object inferred and/or identified by the shadow identification unit (230) will improve.

Meanwhile, if the inferred or identified natural object is determined to be inaccurate or false in the cross-verification step (S530), the characteristics for inferring the natural object of that shadow can be re-evaluated and re-learned. (S531)

For example, if the inferred or identified natural object is false, information that the natural object inferred or identified from the extracted shadow is inaccurate can be stored and updated in the machine learning model generation unit (231). (S532)

Therefore, the machine learning model can be fed back by excluding or lowering the ranking of the falsely determined natural object from candidates for natural objects that can be inferred or identified from the previously extracted shadow.

The machine learning model can repeatedly perform N iterations of the cross-verification step (S530) for natural objects inferred or identified from shadows until a true determination is received. (S533) After that, the natural object verification can be completed (S560).

Meanwhile, referring to FIG. 10, when the shadow identification (S40′) and/or the natural object verification step (S50′) is completed, a natural object information calculation step (S60′) can be performed to calculate beta angle information, direction information, size information, height information, etc. of the natural object from the shadow. The calculated results here may include the beta angle, direction, position (part connected to the shadow), height from the ground, etc. of the natural object.

After step S60′ is completed, the shadow and identified natural object information and results can be stored and fed back to the shadow detection and extraction step (S30′) (S70′). This allows the machine learning model to repeatedly learn shadow characteristics of natural objects, improving the reliability of detecting and extracting shadow characteristics and speeding up information processing.

Additionally, the calculated natural object information and results can be output to the correction module (30) or output module (40). (S80′) The information output in step S80′ can be reprocessed for natural object information in the level 1 image through the correction module (30).

FIG. 12 shows an artificial object (MO) with a relatively clear shape due to high electromagnetic wave reflectivity in a synthetic aperture radar image and its shadow (MOS), while FIG. 13 shows an image of a natural object (NO) with a relatively unclear shape due to low electromagnetic wave reflectivity and its shadow (NOS).

Specifically, the synthetic aperture radar image in FIG. 12 shows an artificial object (aircraft, MO) with high electromagnetic wave reflectivity and its shadow (MOS). The synthetic aperture radar image in FIG. 13 shows a natural object (tree, NO) that electromagnetic waves penetrate and its shadow (NOS).

Referring to FIG. 12, the artificial object (MO) can be seen to form a very dark and clear artificial object (MO) and its corresponding shadow (MOS) due to its high electromagnetic wave reflectivity.

Meanwhile, referring to FIG. 13, the natural object (NO) can be seen to appear as a blurry and unclear shape in the synthetic aperture radar image that is difficult to distinguish what kind of natural object it is due to electromagnetic wave penetration.

However, although the shadow (NOS) of the natural object (NO) may appear lighter in density compared to the shadow (MOS) of the artificial object (MO), it can be seen to be sufficient to infer the natural object (NO) forming the shadow (NOS).

Additionally, the natural object (NO) is a tree among plants, and the tree may have stems, branches, leaves, fruits, etc. on the ground. Therefore, the tree can set shadow characteristics such as differences in thickness between stems and branches, differences in occupied area, and shape differences. Through this, the aforementioned machine learning model can repeatedly learn to infer and/or identify trees as a large classification from shadows, and further infer the type and name of trees.

Therefore, the system and method for detecting natural objects based on synthetic aperture radar images according to an embodiment of the present invention can infer and/or identify natural objects connected to the shadow (NOS) using the shadow (NOS) of the natural object (NO) through a machine learning model.

Moreover, if the shadow (NOS) of the natural object (NO) is enhanced to improve clarity or resolution to the level of the shadow (MOS) of the artificial object (MO), it may be easier to infer and/or identify the natural object (NO) from the shadow (NOS) of the natural object.

1. A system for detecting object information based on a synthetic aperture radar image, comprising:
a receiver module configured to receive an image of a synthetic aperture radar; and
a processing module configured to:
i) extract shadows defined as shaded areas where electromagnetic waves cannot reach in the received image,
ii) distinguish artificial objects that reflect electromagnetic waves in the received image, and
iii) calculate information of the distinguished artificial objects.
wherein the processing module includes a moving target object processing module configured to determine an actual position of a moving object moving with velocity among the artificial objects based on a position of the extracted shadow.

2. The system of claim 1, wherein the moving target object processing module includes:
a boundary setting unit configured to set a boundary based on a maximum velocity of the moving object to match the extracted shadow with the moving object; and
a target-shadow matching unit configured to find and match a shadow of the moving object among the extracted shadows within the set boundary, using a machine learning model.

3. The system of claim 2, wherein the machine learning model is configured to repeatedly generate normalizing data by mixing virtual shadow learning data that simulates changes in synthetic aperture radar environment variables and actual shadow data acquired through actual synthetic aperture radar images.

4. The system of claim 3, wherein the machine learning model is configured to perform repeated learning based on the normalizing data so that an F1-score defined as a harmonic mean of precision and recall is acquired to be 0.8 or higher.

5. The system of claim 2, wherein the boundary setting unit is configured to vary a size of the boundary based on the maximum velocity of the moving object.

6. The system of claim 3, wherein the machine learning model is configured to:
i) simulate and store virtual shadow data according to changes in synthetic aperture radar environment variables based on 3D models of artificial objects with high electromagnetic wave reflectivity to generate virtual shadow learning data, and
ii) learn by mixing the virtual shadow data generated by changes in synthetic aperture radar environment variables and actual shadow data acquired by actual synthetic aperture radar images at a predetermined maximum ratio.

7. The system of claim 2, wherein the target-shadow matching unit includes:
a machine learning model generation unit configured to generate shadow learning data of synthetic aperture radar images for each moving object by distinguishing moving objects by category and generate a machine learning model for shadow detection and matching; and
a matching result acquisition unit configured to match the moving object and shadow through the machine learning model generated by the machine learning model generation unit and acquire information of the moving object based on a position of the shadow,
wherein the matching result acquisition unit is configured to calculate a beta angle defined as an angle between a direction in which the synthetic aperture radar views the moving object and a direction in which the moving object faces forward, from the position of the matched shadow.

8. The system of claim 1, wherein the moving target object processing module further includes:
a target information calculation unit configured to acquire a moving velocity or moving direction of the moving object based on the determined actual position of the moving object; and
a correction module configured to reprocess the synthetic aperture radar image by reflecting the moving velocity or moving direction or shifted position information of the moving object.

9. The system of claim 1, wherein the moving object appears at a position separated from its own shadow in the image received by the receiver module, and
wherein the moving target object processing module is configured to filter out objects connected to shadows in the received image as not being the moving object.

10. The system of claim 2, wherein the receiver module is configured to receive a level 1 image of a single synthetic aperture radar,
wherein the moving target object processing module further includes a target setting unit configured to filter out stationary objects with no velocity in the received level 1 image and target moving objects that are a subject of information detection,
wherein the boundary setting unit is configured to search for a shadow that can be matched with a moving target object by setting a boundary based on the maximum velocity of the moving target object set in the target setting unit,
wherein the target-shadow matching unit is configured to determine a shadow matching the moving target object within the set boundary, and
wherein the moving target object processing module further includes a target information calculation unit configured to calculate velocity and direction information of the moving target object based on the determined shadow.

11. The system of claim 10, wherein the boundary setting unit is configured to determine the boundary by a mathematical formula:
Δ=Rv/V (where Δ is a maximum position displacement for boundary setting, R is a distance between the moving target object and a synthetic aperture radar of a carrier, V is a velocity of the synthetic aperture radar of the carrier, and v is a maximum velocity of the moving target object), and
wherein an actual position of the moving target object in the received level 1 image is determined as a position connected to the matched shadow.

12. The system of claim 1, wherein the processing module further comprises a natural object processing module that distinguishes natural objects that absorb at least a part of electromagnetic waves,
wherein the natural object processing module includes:
a shadow extraction unit that filters among the extract shadows so as to detect and extract a shadow formed by a natural object in the image received from the receiver module; and
a shadow identification unit that identifies the natural object forming the shadow using a machine learning model from the extracted shadows;
wherein the shadow extraction unit is configured to detect the shadow formed by the natural object by selecting a shadow whose visible shape of a source object is unclear in the received image.

13. The system of claim 12, wherein the shadow extraction unit is configured to search for the shadow with unclear visible shapes by applying a window with variable size within the received image.

14. The system of claim 12, wherein the shadow identification unit includes:
a machine learning model generation unit that generates shadow learning data of synthetic aperture radar level 1 images for natural objects classified by category and repeatedly learns to generate a machine learning model; and
a matching result acquisition unit that acquires the natural object identified from the extracted shadows through the machine learning model generated by the machine learning model generation unit,
wherein the machine learning model repeatedly learns about a shadow of a certain natural object characteristic or a characteristic of a shadow that a certain natural object has.

15. The system of claim 12, wherein the natural object processing module further includes:
a shadow enhancement unit that enhances a signal or an image of the shadow that natural objects can form through filtering techniques; and
an object information calculation unit that calculates information about the natural object identified by the shadow identification unit from the extracted shadow.

16. A method for detecting object information based on a synthetic aperture radar image, comprising:
receiving an image of a synthetic aperture radar;
extracting shadows defined as shaded areas where electromagnetic waves cannot reach in the received image;
selecting moving an object with velocity among artificial objects that reflect electromagnetic waves in the received image, excluding a stationary object with no velocity and a shadow connected to the stationary object, to set moving target object;
setting a boundary for the moving target object based on the maximum velocity of the moving target object;
matching the extract shadow located within the set boundary with the moving target object using a machine learning model for the moving target object;
loading beta angle information based on the matched moving target object and shadow in a matching result acquisition step; and
calculating a moving velocity of the moving target object using a mathematical formula
$${V}_{moving velocity} = \frac{{V}_{s} Δ D}{R cos ( β )}$$
(where Vs=velocity of synthetic aperture radar of a carrier, ΔD=distance between a matched shadow and a moving target object, R=distance between the synthetic aperture radar of the carrier and the moving target object, β=angle at which the moving target object is facing based on direction in which synthetic aperture radar views the moving target object), based on the acquired matching result.

17. The method of claim 16, further comprising:
feeding back the matched shadow and moving target object result to a step of the setting a boundary by storing it.

18. The method of claim 16, wherein the machine learning model includes:
inputting 3D models of artificial objects with high electromagnetic wave reflectivity by category to generate virtual shadow data;
generating and storing the virtual shadow data according to changes in synthetic aperture radar environment variables based on the input 3D models;
normalizing by mixing the virtual shadow data generated by combinations of changes in synthetic aperture radar environment variables and an actual shadow data acquired by actual synthetic aperture radar images at a predetermined maximum ratio; and
repeatedly learning based on the normalizing data so that an F1-score is satisfied to be 0.8 or higher.

19. A method for detecting object information in an object information detection system including a receiver module for receiving a synthetic aperture radar image and a processing module for extracting shadows defined as shaded areas where electromagnetic waves cannot reach in the received image and calculating information of natural objects that absorb at least a part of electromagnetic waves based on the extracted shadows, the method comprising:
a filtering step of selecting shadows whose visible source object is not identified among the extracted shadows;
a step of inferring or identifying natural objects from the shadows that passed through the filtering step using a machine learning model; and
a step of calculating information of the inferred or identified natural objects based on a size or a shape of the extracted shadows,
wherein the information of the inferred or identified natural objects includes the position, length, size, and occupied area of the natural objects.

20. The method of claim 19, wherein the machine learning model repeatedly learns about a shadow of a certain natural object characteristic or a characteristic of a shadow that a certain natural object has.
